(19) United States
(12) Patent Application Publication
(10) Pub. No.: US 2020/0389052 A1
(43) Pub. Date: Dec. 10, 2020

(54) BATTERY DEVICE

(71) Applicant: Robert Bosch GmbH, Stuttgart (DE)

(72) Inventors: Dragan Krupezevic, Stuttgart (DE); Juergen Mack, Goeppingen (DE); Martin Gonda, Buehl (DE)

(21) Appl. No.: 16/485,038

(22) PCT Filed: Feb. 1, 2018
(86) PCT No.: PCT/EP2018/052516

§ 371 Date: Sep. 25, 2019

(30) Foreign Application Priority Data
Feb. 10, 2017 (DE) 102017202163.2

(51) Int. Cl. H02J 50/10; H01M 10/44

(52) U.S. Cl. CPC H02J 50/10; B25F 5/02; H01M 2220/30; H01M 10/44

(57) ABSTRACT

A battery device, which has a battery cell unit and at least one inductive charging unit for charging the battery cell unit; the inductive charging unit including at least one inductive charging coil having at least one base winding. The inductive charging coil has at least one secondary winding, whose winding axis runs at least substantially perpendicularly to a winding axis of the base winding.

### FIELD OF THE INVENTION

The present invention is directed to a battery device, which has a battery cell unit and at least one inductive charging unit for charging the battery cell unit.

### BACKGROUND INFORMATION

A battery device having a battery cell unit and at least one inductive charging unit for charging the battery cell unit is believed to have been proposed; the inductive charging unit including at least one inductive charging coil having at least one base winding.

### SUMMARY OF THE INVENTION

The present invention is directed to a battery device, which has a battery cell unit and at least one inductive charging unit for charging the battery cell unit; the inductive charging unit including at least one inductive charging coil having at least one base winding.

It is provided that the inductive charging coil have at least one secondary winding, whose winding axis runs at least substantially perpendicularly to a winding axis of the base winding.

In this connection, a “battery device” is to be understood as, in particular, a device, which is provided, in particular, for storing electrical energy at least temporarily. In particular, a rechargeable energy storage device may be understood by it. In particular, “provided” is to be understood as, in particular, specially programmed, configured and/or equipped. That an object is provided for a particular function, is to be understood to mean that, in particular, the object fulfills and/or executes this particular function in at least one application state and/or operating state. In particular, the battery device may take the form of a handheld power tool battery. A “handheld power tool battery” is to be understood as, in particular, a device having at least one battery cell unit and units for charging and discharging the battery cell unit; the device being configured to supply a handheld power tool with electricity. In this connection, a “handheld power tool” is to be understood as, in particular, an electrical device manually guided by a user, such as, in particular, a drill, a hammer drill, a saw, a planing tool, a screwdriver, a milling tool, a grinder, an angle grinder, and/or a multifunctional tool or a garden tool, such as a hedge trimmer, shrub shears and/or grass clippers. Alternatively, the battery device may also be used with a different, manually operated, electrical device, such as a smart phone or tablet PC. In this connection, a “battery cell unit” is to be understood as, in particular, a rechargeable energy storage unit, which has at least one battery cell, is configured to be charged via introduction of a charging current, and/or is provided for storing electrical energy at least temporarily. In particular, the battery cell unit may include at least one battery cell block, in which a plurality of battery cells are connected in series and/or in parallel. In particular, a “battery cell” is intended to be understood as a unit, which is provided for electrochemical storage of electrical energy via a reversible reaction. For example, the battery cell may be made up of a lead battery cell, a NiCd battery cell, a NiMH battery cell, but which may be a lithium-based battery cell. The battery cell may be made up of battery cells of different nominal voltages, such as nominal voltages of 1.2 V, 1.5 V or 3.6 V. The battery cells may have a cylindrical shape. The battery device may include a plurality of battery cells, which are connected in series and/or in parallel, in order to attain a higher overall voltage of the battery device. For example, the battery device may include a battery cell having a voltage of 3.6 V, two battery cells connected in series, which each have a voltage of 3.6 V for an overall voltage of the battery device of 7.2 V, or three battery cells connected in series, which each have a voltage of 3.6 V for an overall voltage of the battery device of 10.8 V. In particular, the battery device may include a battery housing. A “battery housing” is to be understood as, in particular, a module that includes at least one housing component, which demarcates the battery device from an environment at least partially, using outer walls, and which is configured, in particular, to protect the inductive charging unit from the environment and to prevent damage and/or contamination.

An “inductive charging unit” is to be understood as, in particular, a unit for charging the battery cell unit; the inductive charging unit receiving a charging current by induction and including at least one inductive charging coil and charging electronics. In addition, the inductive charging unit is advantageously configured to control the charging and, in particular, to communicate with an inductive charging device for foreign-object detection. In this connection, an “inductive charging coil” shall be understood as, in particular, a coil having at least one winding made of an electrically conductive material; in at least one operating state, the inductive charging coil being configured to receive electrical energy, which is transmitted by an inductive coil of an inductive charging device, and to supply it to a battery cell via charging electronics. In particular, the inductive charging coil is configured to convert an alternating electromagnetic field to an alternating electrical current. The alternating field may have a frequency of 10-500 kHz, particularly, 100-120 kHz. In particular, the direction is perpendicular to the coil plane and parallel to a winding axis of the inductive charging coil. “Charging electronics” shall be understood to be, in particular, an electronic unit, which is configured to control the charging of battery cells and includes, in particular, electronic elements for transforming voltage.

In this connection, a “base winding” is to be understood as, in particular, a winding of the inductive charging coil, whose winding plane is intended to be oriented at least substantially parallelly to a winding plane of an inductive charging coil of an induction charging device during a charging operation. In this case, “substantially parallelly” is to be understood as, in particular, an orientation of a direction relative to a reference direction, in particular, in a plane; the direction deviating from the reference direction by, in particular, less than 8°, advantageously, less than 5°, and particularly advantageously, less than 2°. In particular, the winding plane of the base winding runs at least substantially perpendicularly to a winding axis of the base winding. In this connection, a “secondary winding” is to be understood as, in particular, a winding of the inductive charging coil, whose winding axis and/or winding plane deviates considerably from a winding axis and/or a winding plane of the base winding in at least one operating state. The base winding of the inductive charging coil may be connected in series with the at least one secondary winding of the inductive charging coil.

Using such an embodiment, a generic battery device may be provided, which has advantageous characteristics with regard to small outer dimensions. In particular, the base winding of the inductive charging coil may have an advantageously small winding diameter due to the configuration of the secondary windings, which means that, in particular, an advantageously small surface area of the inductive charging unit and, consequently, the battery device, may be achieved.

In addition, it is provided that the at least one secondary winding be able to swivel relative to the base winding. In particular, the at least one secondary winding is able to swivel relative to the base winding, about a swivel axis running at least substantially parallelly to the winding plane of the base winding, and which may be about a swivel axis running at least substantially in the winding plane of the base winding. In particular, for positioning relative to an inductive charging coil of an induction charging device during a charging operation, the at least one secondary winding may swivel relative to the base winding. In order to enlarge a charging surface of the inductive charging coil, the at least one secondary winding may be able to swivel into a plane having the base winding. Due to this, a charging surface of the inductive charging coil may be advantageously adapted to an inductive charging coil of an induction charging device. In addition, advantageous energy transmission may be rendered possible. Furthermore, advantageously flexible applicability of the battery device may be rendered possible.

It is also provided that the base winding and/or the at least one secondary winding be mounted at least partially on a flexible substrate. Both the base winding and the at least one secondary winding may be mounted on a flexible substrate, such as a plastic sheet. In particular, the base winding and/or the at least one secondary winding may be printed onto the flexible substrate in the form of a conductive ink. This advantageously allows the inductive charging coil to be fit in flexibly and/or the at least one secondary winding to be easily swiveled relative to the base winding.

In one further refinement of the present invention, it is provided that the battery device include a housing unit; the base winding and/or the at least one secondary winding being at least partially embedded in a wall of the housing unit. In particular, the base winding and/or the at least one secondary winding may be molded at least partially, and which may be, completely, into the wall of the housing unit. In particular, the at least one secondary winding may be embedded in a movably supported wall element of the housing unit, the wall element being pivoted relative to the base winding of the inductive charging coil. This advantageously allows the at least one secondary winding to swivel easily relative to the base winding.

In addition, it is proposed that the inductive charging coil have a plurality of further coil windings, which are situated at a circumference of the base winding. Furthermore, it is provided that the inductive charging coil have three further coil windings, which are each positioned at a circumference of the base winding so as to be offset by 120°. This allows an advantageously large, effective area of the inductive charging coil to be attained.

In addition, an electrical device having at least one battery device of the present invention is provided. In particular, the battery device may be accommodated in a receiving space of the electrical device. In this connection, an “electrical device” is to be understood as, in particular, an electrical device that may be carried by a user, such as a smart phone, a tablet, a laptop, an e-book reader, a handheld power tool, or the like, which is at least partially supplied with electrical energy by the battery device. In particular, a maximum outer dimension of the battery device at least substantially corresponds to a maximum outer dimension of the electrical device in a region of a receiving space for the battery device. In an assembled state, the battery device is at least substantially surrounded by a handle housing of the electrical device. “At least substantially surrounded by a handle housing” shall be understood to mean, in particular, that on at least fifty percent of a length along the major direction of extension, on a plane perpendicular to the major direction of extension, the at least one first battery cell is surrounded by the handle housing along an angular region of at least 180°, and which may be, at least 270°, and particularly, 360°. In the assembled state, the at least one inductive charging coil may be situated at least substantially inside of the handle housing.

“Situated at least substantially inside of the handle housing” shall be understood to mean, in particular, that at least fifty percent, advantageously, at least seventy percent of a volume is situated inside of the handle housing. The electrical device and the battery device may be separated from each other without a tool. “Separable from each other without a tool” is to be understood to mean, In particular, that after being attached to an electrical device, the battery device may be removed from the electrical device by a user without damaging it. The battery device may be configured to be able to be plugged or pushed into the electrical device. In this manner, an advantageously low surface area of the battery device and an advantageously compact handheld power tool may be attained.

In this connection, the battery device of the present invention is not intended to be limited to the application and specific embodiment described above. In particular, in order to achieve a functionality described here, the battery device of the present invention may have a number of individual elements, component parts and units different from a number given here.

Further advantages are derived from the description of the figures that follows. An exemplary embodiment of the present invention is depicted in the drawing. The drawing, the description, and the claims include numerous features in combination. One skilled in the art will necessarily consider the features individually, as well, and unite them to form useful, further combinations.

### BRIEF DESCRIPTION OF THE DRAWING

FIG. 1 shows a partial sectional view of a battery device having an induction charging coil, which includes a base winding and three secondary windings.

FIG. 2 shows a schematic representation of swiveling of the secondary windings relative to the base winding.

FIG. 3 shows an electrical device including the battery device.

### DETAILED DESCRIPTION

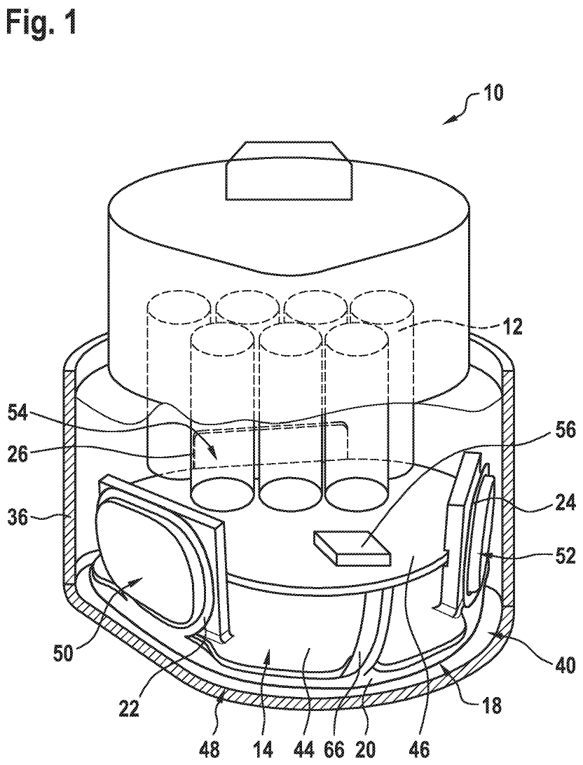

FIG. 1 shows a partial sectional view of a battery device 10. Battery device 10 is provided, in particular, to supply an electrical device not shown here with electrical energy. By way of example, battery device 10 takes the form of a handheld power tool battery device. Battery device 10 includes a housing unit 36. In addition, battery device 10 includes a battery cell unit 12 and an inductive charging unit 14. Battery cell unit 12 is provided for storing electrical energy. In addition, battery cell unit 12 is provided to supply an electrical device not shown here with electrical energy. Battery cell unit 12 is situated in housing unit 36. Inductive charging unit 14 is configured to receive electrical energy for charging battery cell unit 12 by induction. Inductive charging unit 14 includes an inductive charging coil 18, which is configured to receive the electrical energy for charging battery cell unit 12. Inductive charging coil 18 includes a base winding 20. Base winding 20 is made up of a plurality of electrical conductors, which extend in a circumferential direction. In the circumferential direction, the electrical conductors are coiled about a theoretical winding axis of base winding 20. Base winding 20 has a major plane of extension, which is oriented perpendicularly to its winding axis. During a charging operation, base winding 20 is configured to be oriented at least substantially parallelly to a winding plane of an inductive charging coil of an induction charging device not shown. Inductive charging coil 18 includes at least one secondary winding 22, 24, 26. A winding axis of the at least one secondary winding 22, 24, 26 runs at least substantially perpendicularly to a winding axis of base winding 20. Base winding 20 is electrically connected in series to the at least one secondary winding 22, 24, 26. In this case, inductive charging coil 18 includes a plurality of secondary windings 22, 24, 26, which are situated at a circumference 40 of base winding 20. Inductive charging coil 18 may include three secondary windings 22, 24, 26, which are each positioned at circumference 40 so as to be offset by 120°.

Inductive charging unit 14 includes a core unit 44 and an electronic unit 46. Core unit 44 is made at least substantially of a magnetic material, in particular, a ferrite material. Base winding 20 and secondary windings 22, 24, 26 are wound onto core unit 44. Core unit 44 forms winding regions 48, 50, 52, 54 for base winding 20 and secondary windings 22, 22, 24, respectively. Electronic unit 46 is connected to inductive charging coil 18 by a lead 66. In addition, battery device 10 includes a rectifier 56. Inductive charging unit 14 of battery device 10 includes rectifier 56. Electronic unit 46 of inductive charging unit 14 includes rectifier 56. In a charging mode, rectifier 56 is configured to convert an a.c. voltage induced at inductive charging coil 18 for battery cell unit 12 to a d.c. voltage, in order to allow battery cell unit 12 to charge.

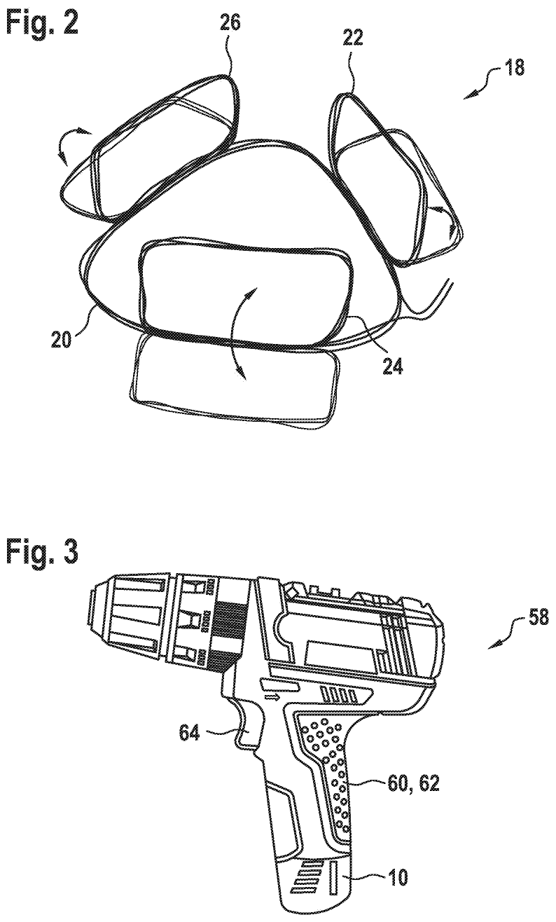

Secondary windings 22, 24, 26 are able to be swiveled relative to base winding 20, in order to adapt the charging surface of inductive charging coil 18. Secondary windings 22, 24, 26 may be swiveled relative to base winding 20, about swivel axes at least substantially parallel to the winding plane of base winding 20, and, which may be, about a swivel axis running at least substantially in the winding plane of base winding 20. In order to enlarge a charging surface of inductive charging coil 18, secondary windings 22, 24, 26 are able to swivel into a plane having base winding 20. The swiveling is schematically represented in FIG. 2. Base winding 20 and/or the at least one secondary winding 22, 24, 26 may be mounted at least partially on a flexible substrate. Alternatively, or in addition, base winding 20 and/or the at least one secondary winding 22, 24, 26 may be embedded at least partially in a wall of housing unit 36.

FIG. 3 shows an electrical device 58 including battery device 10. Electrical device 58 takes the form of a cordless drill/driver that includes a handle 60 having a handle housing 62, which surrounds a battery receptacle. A mechanically operated switch 64, upon manipulation of which an electric circuit between battery device 10 and electrical device 58 closes, so that electrical device 58 is supplied with current for operation, is situated on handle 60.

1-9. (canceled)

10. A battery device, comprising:
a battery cell unit; and
at least one inductive charging unit for charging the battery cell unit, wherein the inductive charging unit includes at least one inductive charging coil having at least one base winding, and wherein the inductive charging coil includes at least one secondary winding, whose winding axis runs at least substantially perpendicularly to a winding axis of the base winding.

11. The battery device of claim 10, wherein the base winding is electrically connected in series to the at least one secondary winding.

12. The battery device of claim 10, wherein the at least one secondary winding is swivel-able relative to the base winding.

13. The battery device of claim 10, wherein to enlarge a charging surface of the inductive charging coil, the at least one secondary winding is swivel-able into a plane including the base winding.

14. The battery device of claim 10, wherein the base winding and/or the at least one secondary winding is mounted at least partially on a flexible substrate.

15. The battery device of claim 10, further comprising:
a housing unit;
wherein the base winding and/or the at least one secondary winding is embedded at least partially in a wall of the housing unit.

16. The battery device of claim 10, wherein the inductive charging coil includes a plurality of secondary windings, which are situated at a circumference of the base winding.

17. The battery device of claim 10, wherein the inductive charging coil includes three secondary windings, which are each situated at a circumference of the base winding so as to be offset by essentially at least 120°.

18. An electrical device, comprising:
at least one battery device, including:
a battery cell unit; and
at least one inductive charging unit for charging the battery cell unit, wherein the inductive charging unit includes at least one inductive charging coil having at least one base winding, and wherein the inductive charging coil includes at least one secondary winding, whose winding axis runs at least substantially perpendicularly to a winding axis of the base winding.
